(19) United States
(12) Patent Application Publication
(10) Pub. No.: US 2026/0034944 A1
(43) Pub. Date: Feb. 5, 2026

(54) TUBE CONTAINER FOR VEHICLES

(71) Applicant: LOKHEN S.R.L., Altamura (Bari) (IT)

(72) Inventors: Giulio ATLANTE, Altamura (Bari) (IT); Giovanni PASTORE, Altamura (Bari) (IT)

(21) Appl. No.: 19/223,526

(22) Filed: May 30, 2025

(30) Foreign Application Priority Data
Aug. 1, 2024 (IT) 102024000018058

(51) Int. Cl. B60R 9/055

(52) U.S. Cl. CPC B60R 9/055

(57) ABSTRACT

A tube container for vehicles has a first part and a second part, both hollow, provided with an inner side wall peripherally closed to delimit a containment compartment, the first and second parts extending along a main longitudinal direction from a cantilevered free end to an inner end, and having a centerline plane parallel to the main longitudinal direction, and a closing lid openable to allow access to the containment compartment. The inner ends directly face and are connected to each other by a joining collar, to create a single device body, the joining collar being superimposed on the inner ends and on an outer side wall of the first and second parts, and having two half-shells connected to each other at opposing bases oriented, with respect to a projection plane parallel to the centerline plane, according to an inclined direction forming an acute angle with the main longitudinal direction.

### CROSS-REFERENCE TO RELATED APPLICATION

This application claims priority to Italian Patent Application No. 102024000018058 filed Aug. 1, 2024, the entire contents of which is hereby incorporated in its entirety by reference.

### FIELD OF APPLICATION

The present invention relates to an improved tube container for vehicles.

### BACKGROUND ART

As is known, in the field of both industrial and non-industrial vehicles, tube containers are used, normally placed on the roof of the vehicle, directly or by interposing luggage bars in turn attached to the roof of the vehicle.

Such tube containers must have precise technical features in order to withstand the harsh conditions to which they are subjected.

First, these are containers placed outdoors, on the roof of the vehicle, and therefore must withstand atmospheric agents, ensuring the hermeticity over time, in particular avoiding possible water infiltrations therein.

Furthermore, they must ensure considerable mechanical resistance to impacts, especially avoiding the dispersion of the objects contained therein in the event of strong decelerations of the vehicle to which they are applied (e.g., in the event of impacts or accidents that can involve the vehicle).

Moreover, these tube containers must be capable of ensuring easy accessibility to the containment compartment thereof in order to allow the removal of the objects stored therein. Furthermore, once the access to the containment compartment has been opened by rotating the appropriate closing lid, it is necessary to avoid the closing lid itself from accidentally closing, for example due to its own weight, the wind or even because the vehicle is on a slope, i.e., on a road that is not perfectly flat.

The longitudinal dimensions of tube containers can vary greatly depending on the type of vehicle with which they are associated.

For these reasons, in order to reduce production costs and avoid creating specific lengths for each type of vehicle, it is known to manufacture the tube containers in two tube parts conveniently connected to each other at the inner ends, mutually facing each other. The respective outer ends, opposite to the inner ends, are provided with caps, usually made of plastic, which act as a bottom and as an opening for the insertion of objects into the tube containers.

The connection of the inner ends of the parts, mutually facing each other, is a crucial element.

In fact, such a connection must simultaneously ensure mechanical resistance and impermeability to water or external agents.

Such a connection is mechanically stressed as it represents a cantilevered point for each part which is in turn constrained, at the opposite outer end, to a vehicle support structure, such as bars fixed to the roof of the vehicle itself, for example.

Furthermore, it is necessary for such connection joints to be easily and quickly assemblable, so as to reduce assembly times and costs.

Connection joints are known, comprising two metal half-shells, possibly covered with plastic sheets, fixed together by screws or pins.

On the one hand, such solutions ensure the necessary mechanical resistance and impermeability, but on the other hand, they are expensive to manufacture and assemble.

Therefore, the solutions of the prior art are not capable of solving the above-

mentioned technical problems.

### SUMMARY OF THE INVENTION

Therefore, the need is felt to solve the drawbacks and limitations mentioned with reference to the prior art.

Such a need is met by a tube container as described and claimed herein.

### DESCRIPTION OF THE DRAWINGS

Further features and advantages of the present invention will be more comprehensible from the following description of preferred, non-limiting embodiments thereof, in which:

FIG. 1 depicts a perspective view of a tube container for vehicles in an assembled configuration, according to an embodiment of the present invention;

FIG. 2 depicts the tube container in FIG. 1, in a partially exploded configuration and with the lid open;

FIG. 3 depicts the enlarged detail III of FIG. 1;

FIG. 4 depicts a perspective view of a part of the tube container for vehicles in FIG. 1;

FIG. 5 depicts a top view of the tube container for vehicles in FIG. 1, from the side of the arrow V indicated in FIG. 3;

FIG. 6 depicts a perspective view of a part of a tube container for vehicles according to a further embodiment of the present invention;

FIG. 7 depicts a perspective view of a bracket for assembling the tube container in FIG. 6;

FIG. 8 depicts a perspective view of a tube container according to a further embodiment of the present invention;

FIG. 9 depicts the enlarged detail IX indicated in FIG. 8; and

FIGS. 10-12 depict enlarged details of the tube container in FIG. 8.

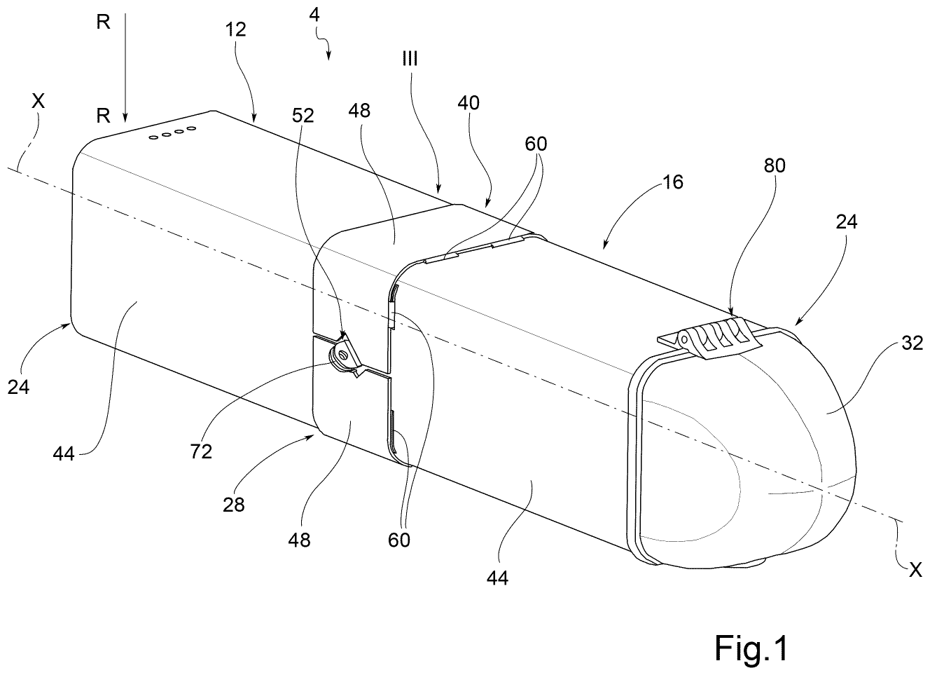

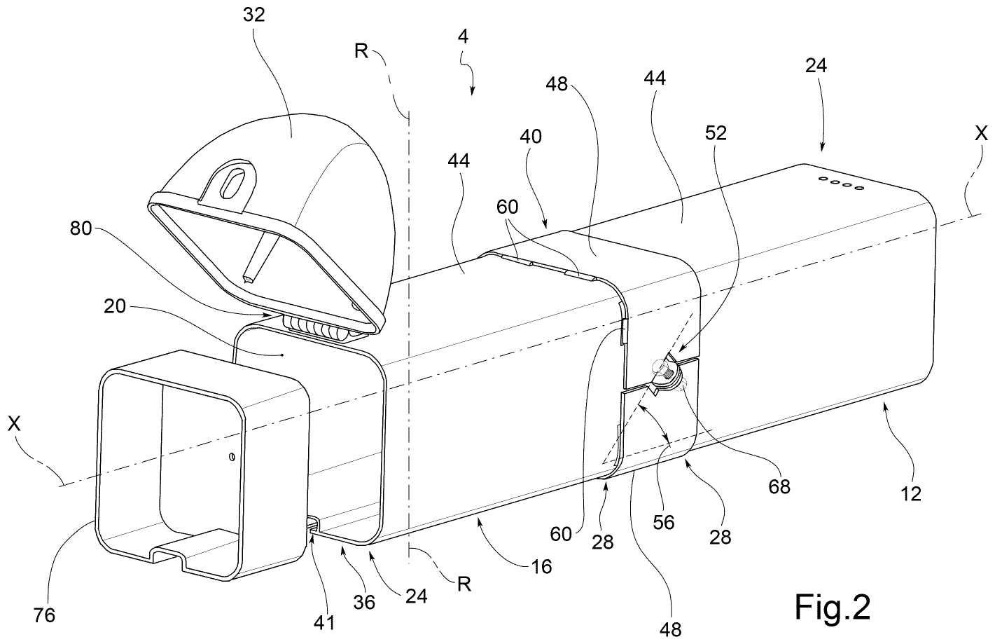

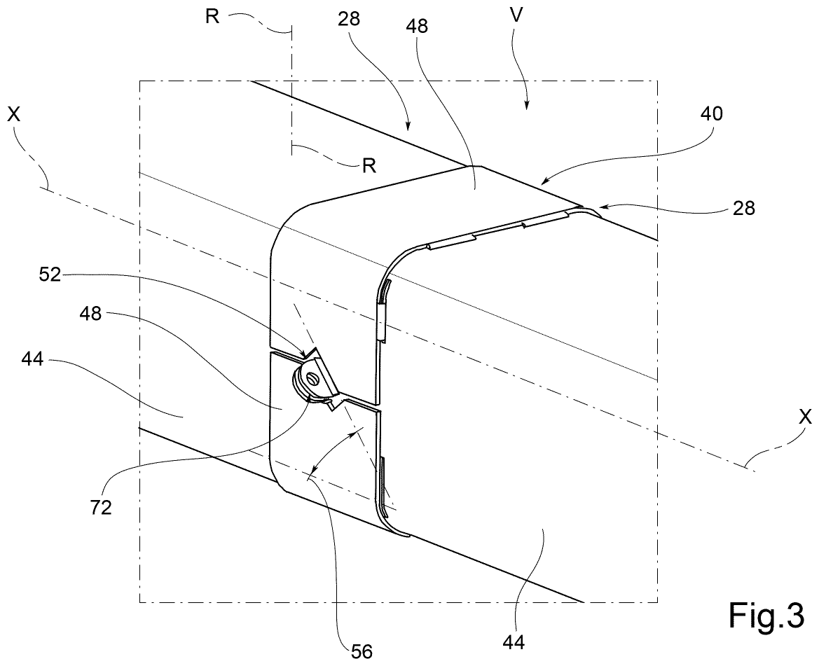

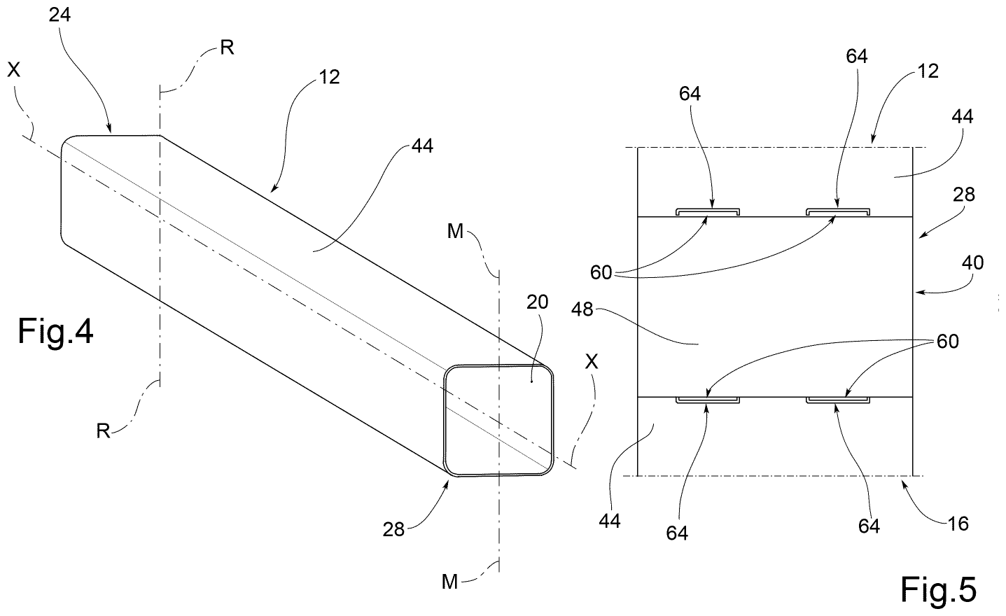

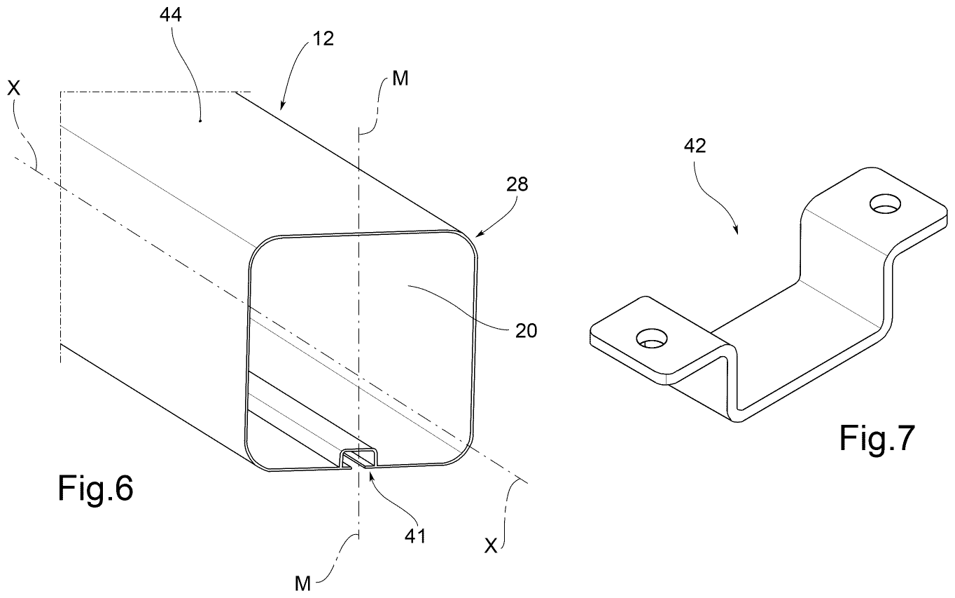

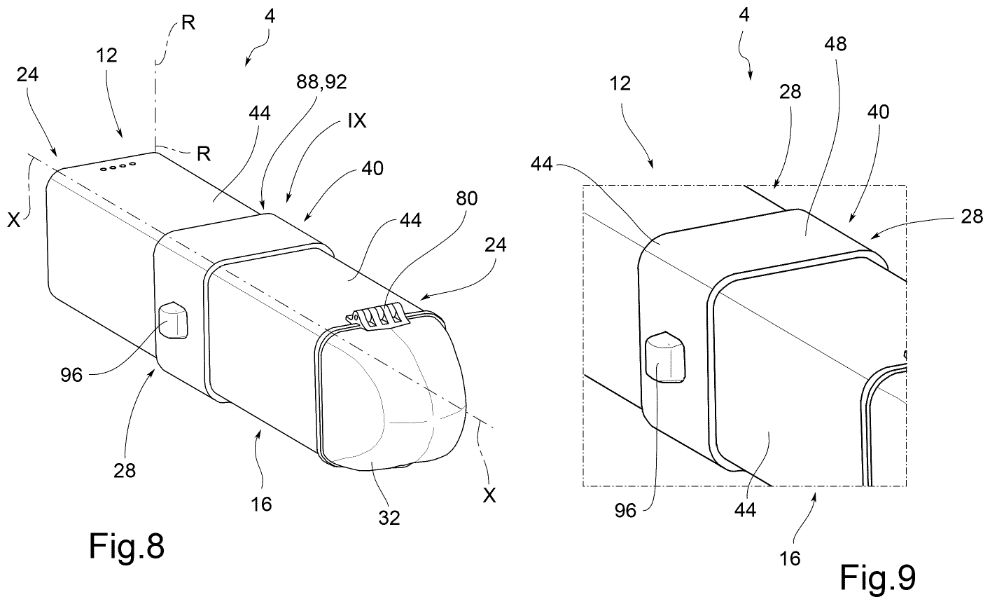

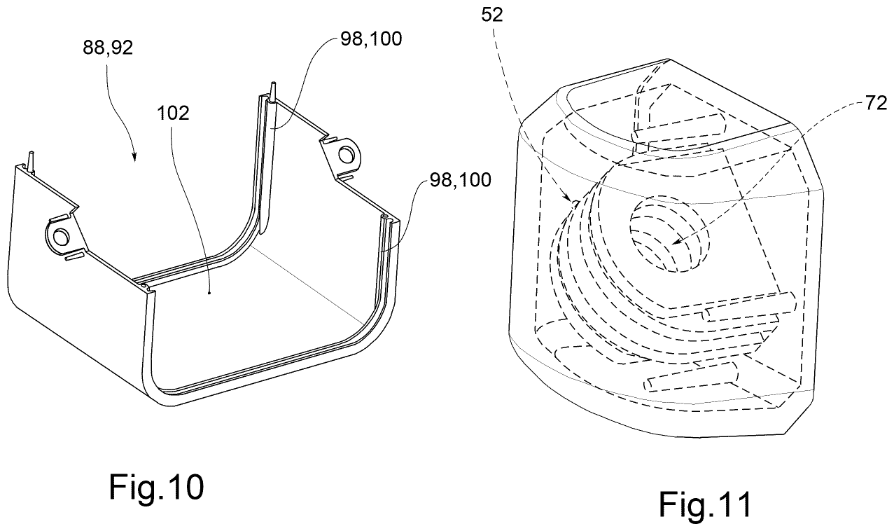

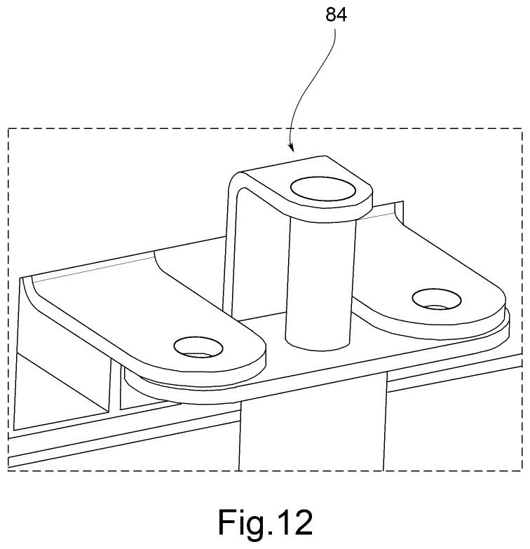

The elements or parts of elements common to the embodiments described below will be indicated by the same reference numerals.

### DETAILED DESCRIPTION

With reference to the above figures, reference number 4 indicates as a whole a tube container for vehicles comprising a hollow device body which delimits a containment compartment 8 for objects.

In particular, the tube container 4 preferably contains elongated objects, such as tubes but not only. In any case, the type of objects contained in the containment compartment 8 is only indicative and not limiting for the purposes of the present invention.

The tube container 4 for vehicles comprises a first hollow part 12 and a second hollow part 16, provided with an inner side wall 20 peripherally closed so as to delimit a containment compartment 8 for objects.

The first part 12 and the second part 16 each extend along a main longitudinal direction X-X from a cantilevered free end 24 to an inner end 28 opposite to the free end 24. The first part 12 and the second part 16 have a centerline plane M-M parallel to the main longitudinal direction X-X. Preferably, the centerline plane M-M is also a plane of symmetry for the tube container 4. The inner ends 28 are open so as to create the single containment compartment 8 seamlessly between the first part 12 and the second part 16.

The parts 12, 16 may be made of either metal or plastic/polymer material.

A closing lid 32 is associated with the free end 24 of at least one of the parts 12,16, openable so as to allow access to the containment compartment 8, through an access threshold 36 thereof. Typically, at least one closing lid 32 is instead of the fixed type.

The inner ends 28 of the parts 12,16 directly face and are connected to each other by at least one joining collar 40, so as to create a single device body, parallel to the main longitudinal direction X-X.

According to an embodiment, at least one of the parts 12, 16 has a longitudinal bottom slit 41, arranged parallel to the main longitudinal direction X-X. In particular, the longitudinal bottom slit 41 facilitates the assembly of the tube container on a luggage rack of an associable vehicle due to the interposition of at least one Omega bracket 42 which fits into the longitudinal bottom slit 41.

In particular, the joining collar 40 is superimposed on the inner ends 28 of the parts 12,16 and on an outer side wall 44 opposite to the inner side wall 20 of the parts 12,16.

Preferably, the joining collar 40 comprises two half-shells 48 connected to each other at opposing bases 52 oriented, with respect to a projection plane parallel to the centerline plane M-M, according to an inclined direction forming an acute angle 56 with the main longitudinal direction X-X. As better described hereinafter, the presence of this angle allows obtaining, by bringing the two half-shells 48 closer and tightening them together, both an axial compressive force between the two parts parallel to the main longitudinal direction X-X, and a radial compressive force, along a radial direction R-R, parallel to the centerline plane M-M and perpendicular to the main longitudinal direction X-X.

According to an embodiment, the acute angle 56 is an angle between 40 and 50 sexagesimal degrees, preferably equal to 45 sexagesimal degrees.

According to an embodiment, each half-shell 48 comprises at least one folded flap 60 inserted at least partially into a corresponding seat 64 formed on the outer side wall 44 of each inner end 28 of the first part 12 and the second part 16.

Preferably, the seat 64 is blind, i.e., it is not a through seat and thus not communicating with the containment compartment 8. It is also possible to provide an embodiment in which the seat is a through seat in communication with the containment compartment 8.

For example, the folded flap 60 identifies an angle of about 90 sexagesimal degrees with the corresponding half-shell 48.

Preferably, threaded connection means 68, such as screws or bolts, are provided at the bases 52 for closing the half-shells so as to vary both the tightening torque between the half-shells 48 and the compressive force between the first part 12 and second part 16 as a function of the torquing of the screws or bolts. The threaded connection means 68 pass through appropriate fixing holes 72 obtained on the bases 52.

Preferably, the half-shells 48 are made of steel.

According to an embodiment, at the at least one free end 24 provided with a closing lid 32, there is an inner anti-breakthrough plate 76 which internally covers free end 24 on the side of the inner side wall 20. For example, the inner anti-breakthrough plate 76 is a steel ring.

According to an embodiment, the free end 24 equipped with a closing lid 32 is provided with an incorporated half-hinge 80 to allow the closing lid 32 to be opened/closed.

According to an embodiment, the closing lid 32 is provided with a closing lock 84.

Preferably, the closing lock 84 is a lock of the push-button type.

According to an embodiment, a plastic cover 88 is provided to cover the joining collar 40.

According to an embodiment, the plastic cover 88 comprises a pair of half-lids 92 associated with each other by an interlocking and/or snap-fit form coupling.

For example, the half-lids 92 comprise a pair of hollow protuberances 96 counter-shaped with respect to the bases 52, to cover the latter.

According to an embodiment, the protuberances 96 are shaped so as to house and conceal the bases 52 and the threaded connection means 68 thereof, such as screws or bolts.

According to an embodiment, the half-lids 92 are provided with peripheral gaskets 98 arranged upstream and downstream of the inner ends 28 of the parts 12,16.

According to an embodiment, the peripheral gaskets 98 are housed within peripheral seats 100 formed on an inner wall 102 of the half-lids 92 facing the outer side wall 44 of the parts 12,16.

Due to the radial tightening of the half-lids 92 it is thus possible to compress the peripheral gaskets 98 against the outer side wall of the parts 12,16.

The peripheral gaskets run along the entire outer periphery of the inner ends 28 of the parts 12,16 so as to form a seal for the containment compartment 8.

As can be appreciated from the above description, the present invention allows overcoming the drawbacks introduced in the prior art.

In fact, the present invention allows withstanding atmospheric agents, ensuring the required hermeticity over time, in particular avoiding possible infiltrations of water into the containment compartment.

Furthermore, the tube container is solid, equipped with adequate sealing gaskets, and due to the joining collar, does not include rivets or through holes passing through the walls and directly exposed to the outside of the device, as in many solutions of the prior art; such rivets or through holes are in fact the cause of water infiltration in the long run.

Moreover, the connection provided by the joining collar is particularly mechanically resistant.

In particular, the provision of inclined bases allows, by tightening the threaded connection means, both compressing the two parts axially together along the main longitudinal direction X-X, and compressing the two half-shells radially. Also due to the mechanical connection between the folded flaps and the blind seats, the joining collar is capable of ensuring a stable and safe mechanical connection.

Moreover, the present invention is inexpensive and versatile to manufacture and assemble. In particular, unlike some solutions of the prior art, the overall assembly time is reduced as the pre-assembly of the half-shells on the parts is not required.

Furthermore, the solution of the present invention is aesthetically superior to the prior art solutions as the folded flaps that fit into the blind seats ensure a more precise alignment between the parts. In addition, the present invention allows connecting together several parts typically obtained by extrusion; the fact that the parts have a reduced longitudinal extension allows obtaining more dimensionally precise components, which are thus easier to align and assemble.

On the one hand, the joining collar forms a structural stiffening element, and on the other hand it ensures the seal by virtue of the provision of sealing gaskets, conveniently pressed against the outer side wall of the parts.

In any case, the longitudinal extension of the joining collar of the present invention is highly reduced compared to the longitudinal extension of the prior art solutions, precisely by virtue of the presence of the mechanical connections between the folded flaps and the blind seats, which significantly contribute to the overall structural rigidity of the device.

In other words, due to the presence of mechanical connections that align and stiffen the connection between the parts, it is possible to use a joining collar with fairly limited longitudinal dimensions.

In order to meet contingent, specific needs, those skilled in the art may make several changes and variations to the solutions described above.

The scope of protection of the present invention is defined by the following claims.

### REFERENCE SIGNS

4: tube container
8: containment compartment
12: first part
16: second part
20: inner side wall
24: free end
28: inner end
32: closing lid
36: access threshold
40: joining collar
41: longitudinal bottom slit
42: Omega bracket
44: outer side wall
48: half-shells
52: bases
56: acute angle
60: folded flap
64: seat
68: threaded connection means
72: fixing holes
76: inner anti-breakthrough plate
80: half-hinge
84: closing lock
88: plastic cover
92: half-lid
96: protuberances
98: peripheral gaskets
100: peripheral seats
102: inner wall
X-X: main longitudinal direction
M-M: centerline plane
R-R radial direction

What is claimed is:

1. A tube container for vehicles comprising:
a first part and a second part, both hollow, provided with an inner side wall peripherally closed so as to delimit a containment compartment for objects, the first part and the second part each extending along a main longitudinal direction from a cantilevered free end to an inner end opposite to the free end, and having a centerline plane parallel to the main longitudinal direction, and
a closing lid, associated with the free end of at least one of the first and second parts, openable to allow access to the containment compartment, through an access threshold thereof,
the inner ends of the first and second parts directly facing and being connected to each other by at least one joining collar, so as to create a single device body, parallel to the main longitudinal direction, the at least one joining collar being superimposed on the inner ends of the first and second parts and on an outer side wall opposite to the inner side wall of the first and second parts,
wherein the at least one joining collar comprises two half-shells connected to each other at opposing bases oriented, with respect to a projection plane parallel to the centerline plane, according to an inclined direction forming an acute angle with the main longitudinal direction.

2. The tube container of claim 1, wherein the acute angle is between 40 and 50 sexagesimal degrees.

3. The tube container of claim 1, wherein each half-shell comprises at least one folded flap inserted at least partially into a corresponding seat formed on the outer side wall of each inner end of the first part and second part.

4. The tube container of claim 3, wherein the at least one folded flap identifies an angle of about 90 sexagesimal degrees with the corresponding half-shell.

5. The tube container of claim 1, wherein threaded connection means, optionally the threaded connection mean being screws or bolts, are provided at the bases for closing the two half-shells so as to vary both a tightening torque between the two half-shells and a compressive force between the first part and the second part as a function of torquing of the screws or bolts.

6. The tube container of claim 1, wherein the two half-shells are made of steel.

7. The tube container of claim 1, wherein, at the free end provided with the closing lid, is provided an inner anti-breakthrough plate which internally covers the free end on a side of the inner side wall.

8. The tube container of claim 1, wherein the free end equipped with the closing lid is provided with an incorporated half-hinge to allow the closing lid to be opened/closed.

9. The tube container of claim 1, wherein the closing lid is provided with a closing lock.

10. The tube container of claim 9, wherein the closing lock is a lock of push-button type.

11. The tube container of claim 1, wherein a plastic cover is provided to cover the at least one joining collar.

12. The tube container of claim 11, wherein the plastic cover comprises a pair of half-lids associated with each other by an interlocking and/or snap-fit form coupling.

13. The tube container of claim 12, wherein the half-lids comprise a pair of hollow protuberances counter-shaped with respect to the bases to cover the bases.

14. The tube container of claim 13, wherein the hollow protuberances are shaped so as to house and conceal the bases and threaded connection means of the bases, optionally the threaded connection means being screws or bolts.

15. The tube container of claim 12, wherein the half-lids are provided with peripheral gaskets arranged upstream and downstream of the inner ends of the first and second parts.

16. The tube container of claim 15, wherein the peripheral gaskets are housed within peripheral seats formed on an inner wall of the half-lids facing the outer side wall of the first and second parts.

17. The tube container of claim 1, wherein at least one of the first and second parts has a longitudinal bottom slit, arranged parallel to the main longitudinal direction, shaped to facilitate an assembly of the tube container on a luggage rack of an associable vehicle due to an interposition of at least one Omega bracket.

18. The tube container of claim 1, wherein the acute angle is equal to 45 sexagesimal degrees.
